(19) United States
(12) Patent Application Publication
(10) Pub. No.: US 2008/0052361 A1
(43) Pub. Date: Feb. 28, 2008

(54) Method and system for managing a process through an e-mail client

(75) Inventors: Piyush Ahuja, New Delhi (IN); Sanjay Dutt, New Delhi (IN)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/509,046

(22) Filed: Aug. 24, 2006

(51) Int. Cl. G06F 15/16; G06F 3/00

(52) U.S. Cl. 709/206; 715/753

(57) ABSTRACT

A process, such as a training program, is managed through an e-mail client. The process includes one or more datasets such as training programs. The one or more training programs are scheduled, based on one or more categories such as the date, time and location of the training. Users associated with the training programs provide their feedback on the training. This feedback is collected and combined with the one or more categories. Thereafter, one or more reports are generated, based on these categories, and used for managing the process.

### BACKGROUND OF THE INVENTION

1. Field of the Invention

The present invention relates generally to process management. More specifically, it relates to a system for managing a process through an email client.

2. Related Art

Managing a training program in an organization requires scheduling various training programs and informing employees about them. This also includes marking the attendance of the employees, collecting training feedback from them, and generating various reports, based on the feedback. Since the number of employees is less in small organizations, the process of scheduling the training programs and informing the employees about them may be performed manually. Moreover, the reports may be generated manually. However, the number of training programs that need to be scheduled and the number of employees that needs to be informed increases as the organization grows. Therefore, informing the employees manually about each training program becomes difficult. Moreover, the employees may be present at different geographical locations, which make manual collection of feedback more cumbersome.

Various software applications, such as web-based applications, are available that schedule the trainings programs and electronically inform the employees about them. The employees may be informed electronically by putting up the training programs on a website, which the employees present in various geographical locations may access through the Internet. Another way of informing the employees is through e-mails. However, these software applications are implemented as stand-alone applications and need to be installed separately.

In light of the above discussion, there is a need for a computer program product, system and method for managing a process that does not require manual intervention, which can be integrated with an existing system, and which generates process management reports automatically.

### BRIEF DESCRIPTION OF THE INVENTION

The present invention meets the needs identified above by providing a computer program product, system and method for managing a process through an e-mail client.

An advantage of the present invention is that it provides a method for managing the process of various datasets, such as a training program, through an e-mail client.

Another advantage of the present invention is that it provides a method for collecting the feedback of one or more datasets automatically.

Yet another advantage of the present invention is that it provides a method for automatically generating reports of a process.

Further features and advantages of the present invention, as well as the structure and operation of various embodiments of the present invention, are described in detail below with reference to the accompanying drawings.

### BRIEF DESCRIPTION OF THE DRAWINGS

The features and advantages of the present invention will become more apparent from the detailed description set forth below, when taken in conjunction with the drawings in which like reference numbers indicate identical or functionally similar elements. Additionally, the left-most digit of a reference number identifies the drawing in which the reference number first appears.

FIG. 1 is a block diagram of an exemplary environment in which the present invention may be implemented.

FIG. 2 is a block diagram illustrating a system for managing a process through an e-mail client, according to one embodiment of the invention.

FIG. 3 is a block diagram illustrating a system for managing a process through an e-mail client, according to another embodiment of the invention.

FIG. 4 is a flowchart of a method for managing a process through an e-mail client, in accordance with an embodiment of the present invention.

FIG. 5 is an exemplary window or screenshot generated by the graphical user interface of the present invention.

FIG. 6 is another exemplary window or screenshot generated by the graphical user interface of the present invention.

FIG. 7 is yet another exemplary window or screenshot generated by the graphical user interface of the present invention.

FIG. 8 is a block diagram of an exemplary computer system that is useful for implementing the present invention.

### DETAILED DESCRIPTION

### I. Overview

The present invention provides a computer program product, system and method for managing a process such as a training program through an e-mail client. The e-mail client uses a communication network to connect one or more users. The process includes one or more datasets such as training programs. Each dataset may be identified by one or more categories, such as the date, duration, cost, location, title, mode, training type, username, user level and user group. The datasets are scheduled by the users, based on these categories. Further, the feedback provided by the users on the one or more datasets is collected through the e-mail client. The feedback is used to generate reports on the datasets, based on the categories.

The present invention is now described in more detail herein in terms of the above exemplary system. This is for convenience only and is not intended to limit the application of the present invention. In fact, after reading the following description, it will be apparent to one skilled in the relevant art(s) how to implement the following invention in alternative embodiments, e.g., in a manufacturing environment for managing a process, generating various reports, etc.

The terms “user,” “administrator”, “employees” and/or the plural form of these terms are used interchangeably throughout herein, to refer to those persons or entities that are capable of accessing, using, being affected by and/or benefiting from the tool the present invention provides for managing a process.

### II. System

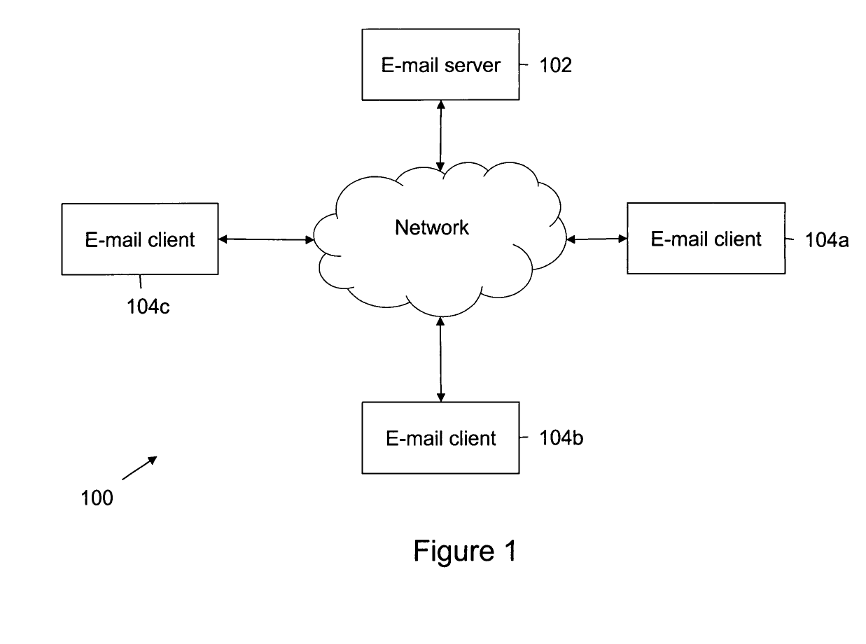

FIG. 1 is a block diagram illustrating a network 100 in which various embodiments of the invention may be practiced. Network 100 includes an e-mail server 102, an e-mail client 104a, an e-mail client 104b, and an e-mail client 104c. E-mail client 104a, e-mail client 104b and e-mail client 104c, hereinafter referred to as one or more e-mail clients 104, are computer programs that are used for reading and sending e-mails in network 100. E-mail server 102 is a computer program for transferring e-mails between one or more e-mail clients 104. The data associated with one or more e-mail clients 104 is stored in e-mail server 102. Examples of the data may include e-mail messages, the contact addresses of the users, user groups, the list of group leaders, the level of the users, and the like. One or more users may access e-mails through one or more e-mail clients 104.

In various embodiments of the present invention, network 100 may be a wired or wireless network. Examples of network 100 include, but are not limited to, a Local Area Network (LAN), a Wide Area Network (WAN), a Metropolitan Area Network (MAN), and the Internet. Examples of e-mail servers may include Lotus domino Server®, Microsoft Exchange Server®, and the like. Examples of e-mail clients 104 include Lotus Notes®, Microsoft Outlook™, Netscape®, Opera®, Eudora®, Mozilla®, and the like.

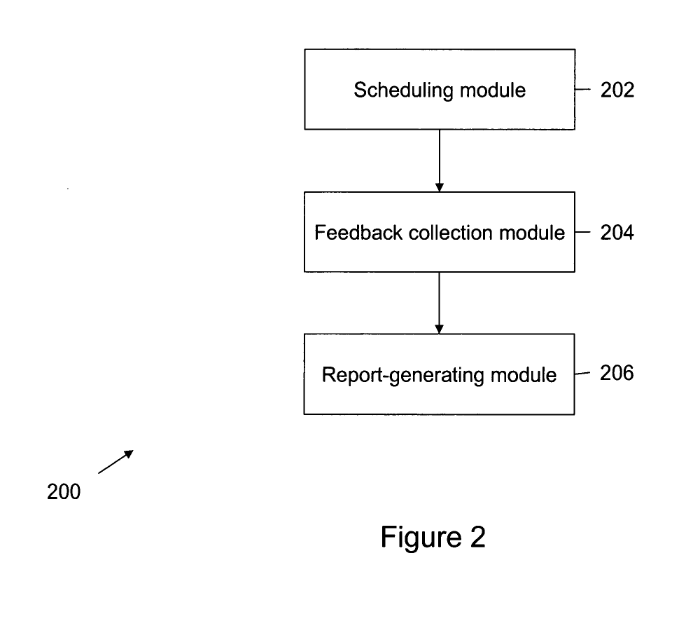

FIG. 2 is a block diagram illustrating a system 200 for managing a process through an e-mail client, according to an embodiment of the present invention. System 200 includes a scheduling module 202, a feedback collection module 204, and a report-generating module 206. System 200 manages the process on an existing system such as the e-mail client. Examples of the process may be a training program, a meeting program, and the like. The process includes one or more datasets. Examples of the one or more datasets include training programs, presentations, meetings, seminars, workshops, and the like. Further, each dataset includes one or more categories such as the date, duration, cost, location, title, mode, training type, username, and user level and user group.

Scheduling module 202 schedules one or more datasets such as training on e-mail client 104. The schedule of the datasets is based on the one or more categories. One or more users are associated with each dataset. The users may be group leaders, administrators, training planners, employees, and the like. The users provide feedback of the datasets through one or more e-mail clients 104, which is collected by feedback collection module 204. Examples of the feedback may include, but are not limited to, the attendance of the users, the rating of datasets, feedback and suggestions on datasets, and the like. Report-generating module 206 generates one or more reports of the datasets, based on the one or more categories.

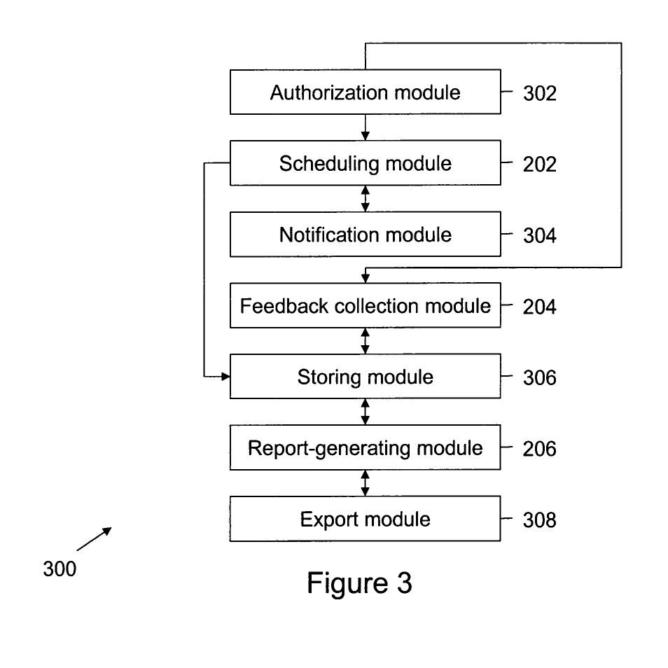

FIG. 3 is a block diagram illustrating a system 300 for managing a process through an e-mail client, according to another embodiment of the present invention. System 300 includes an authorization module 302, a notification module 304, a storing module 306, an export module 308, scheduling module 202, feedback collection module 204, and report-generating module 206.

Scheduling module 202 schedules one or more datasets such as training on e-mail client 104. Scheduling may be initiated by one or more users, based on one or more categories. Authorization module 302 authorizes the one or more users to schedule the one or more datasets. Moreover, authorization module 302 provides various rights such as the scheduling and modification associated with the datasets. Therefore, a user such as an administrator with scheduling rights may create, modify or delete the categories and datasets associated with the process. This results in securing system 300 by enabling privileged access to the different modules of system 300.

Notification module 304 notifies the users about the scheduling of the one or more datasets. This notification may be sent in the form of an e-mail, which may be accessed by users through one or more e-mail clients 104. Feedback collection module 204 collects feedback on the datasets from the users. The users may send their feedback through one or more e-mail clients 104. In an embodiment of the present invention, feedback may be collected by filling-in (i.e., completing) an electronic form, which is integrated with e-mail client 104. In an embodiment of the present invention, authorization module 302 provides rights to the users to view only their own feedback. For example, feedback submitted by a first user is not accessible to a second user. Moreover, authorization module 302 may provide rights to a user such as an administrator to view and modify the feedback of the one or more users. In various embodiments of invention, the feedback is combined with the one or more categories associated with the respective datasets.

Storing module 306 stores process management information associated with the process. Examples of process management information include the feedback and the one or more categories associated with the datasets. The process-management information associated with the process may be accessed by the users through one or more e-mail clients 104. In accordance with an embodiment of the present invention, the process management information is stored in a Lotus Notes® database.

The users may generate one or more reports of the datasets through report-generating module 206. The reports are generated based on the categories of the datasets stored in storing module 306. In an embodiment of the invention, report-generating module 206 generates reports of the feedback received from the users.

Export module 308 exports the one or more reports in a pre-defined file format. Examples of the pre-defined file format include, but are not limited to, the Microsoft Outlook™ format, the Lotus Notes® format, the Microsoft Word™ format, Microsoft Excel™ format, the Extensible Markup Language (XML), the Hypertext Markup Language (HTML), the Post Description File (PDF), the template (xlt), and the text format.

In an embodiment of the present invention, authorization module 302, notification module 304, storing module 306, and feedback collection module 204 are present on e-mail server 102. Further, export module 308, scheduling module 202 and report-generating module 206 are present on e-mail client 104.

### III. Process

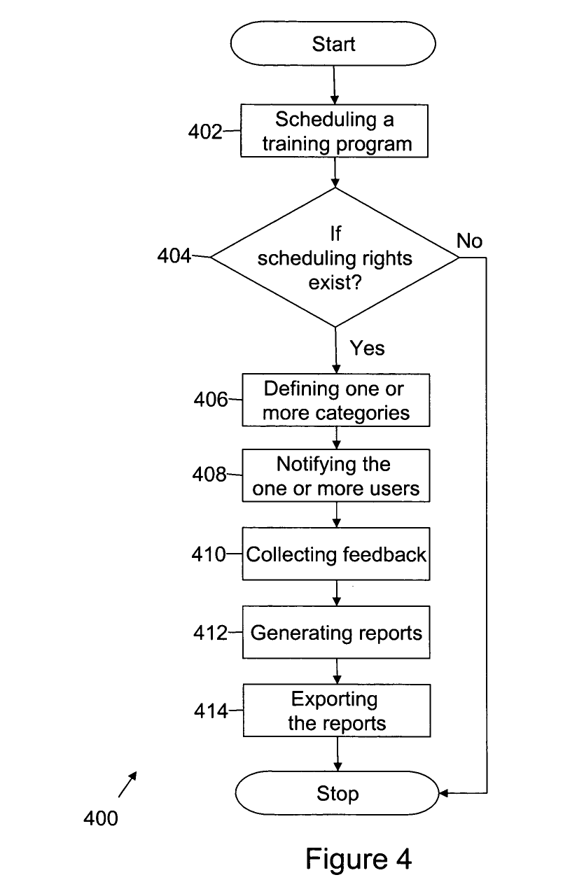

FIG. 4 is a flowchart illustrating a process 400 for managing a process through an e-mail client, according to an embodiment of the present invention. Process 400 begins at step 402, where an administrator initiates a training program that is to be scheduled through e-mail-client 104. At step 404, it is determined if the administrator has the right to schedule the training. If the administrator does not have scheduling rights, the training cannot be scheduled. However, if the administrator has scheduling rights, one or more categories of the training program are defined by the administrator at step 406. These one or more categories may be the title of the training, the description of the training, the location of the training, the time of the training, the period of the training, the name of the trainer, the list of trainees, the mode of training, the type of training, the cost of training, etc. The mode of training may be, for example, classroom-based, telephonic, online conference, online tutorials, and the like. The type of training may be, for example, business training, leadership training, knowledge training, marketing training, sales training, and the like.

Thereafter, one or more users, such as trainees, are notified about the training through an e-mail at step 408. The e-mail is accessed by the trainees through one or more e-mail clients such as Lotus Notes®. The notification to the trainees includes the one or more categories associated with the training. Further, feedback is collected from the one or more users associated with the training at step 410. The feedback may include, for example, but is not limited to, the attendance of the trainees, the rating of the training, and the comments made and suggestions on the training. The suggestions on the training may be based on, for example, various parameters such as presentation, voice quality and communication skills associated with the trainer and the training. The feedback collected by the users is combined with the one or more categories associated with the training and stored.

At step 412, one or more reports are generated, based on the one or more categories. For example, a user may generate a list of training programs, scheduled at specific locations such as Washington, D.C. The user may also generate a list of training programs attended by an employee or a group of employees and manage the training programs to be undertaken by them. Similarly, a report on a list of training programs conducted in a month may be generated, which includes information pertaining to the one or more categories such as the date, duration, cost, location, title, mode, training type, username, user level and user group associated with each training program. Further, the one or more reports are exported in a Microsoft Excel™ format at step 414. These reports may be used by the group leaders to manage the training program.

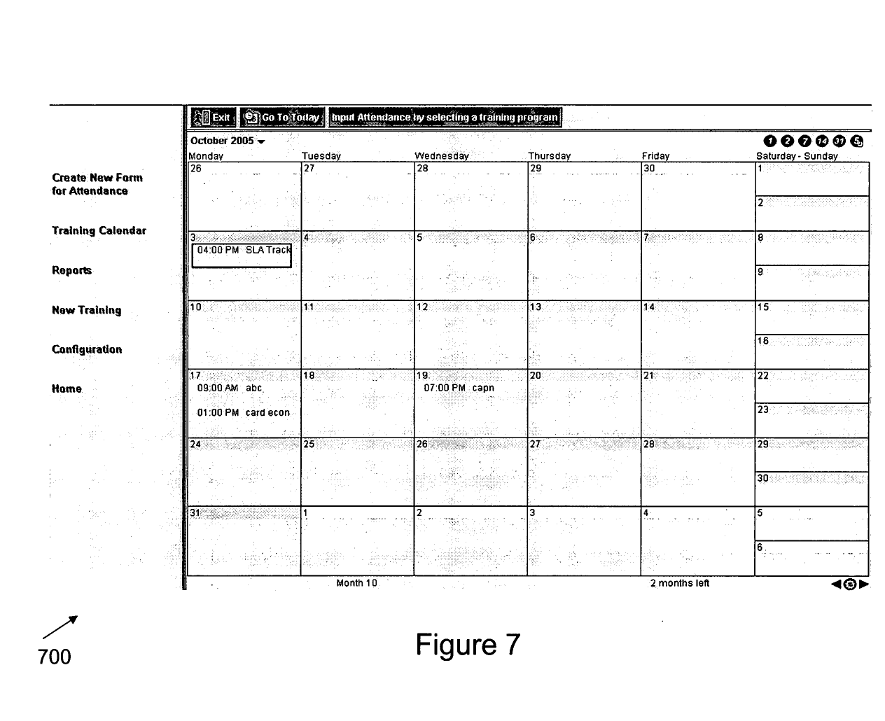

In an embodiment of the present invention, the training programs and the feedback may be searched, based on the one or more categories. In an embodiment of the present invention, the training program may be visually represented in a calendar format. A screenshot of an example calendar format I shown in FIG. 7.

The present invention provides a computer program product, method and system for managing a process through an e-mail client. Further, feedback such as attendance of the training programs may be collected through the e-mail client. Moreover, various reports may be generated without manual intervention.

### IV. Exemplary Implementation

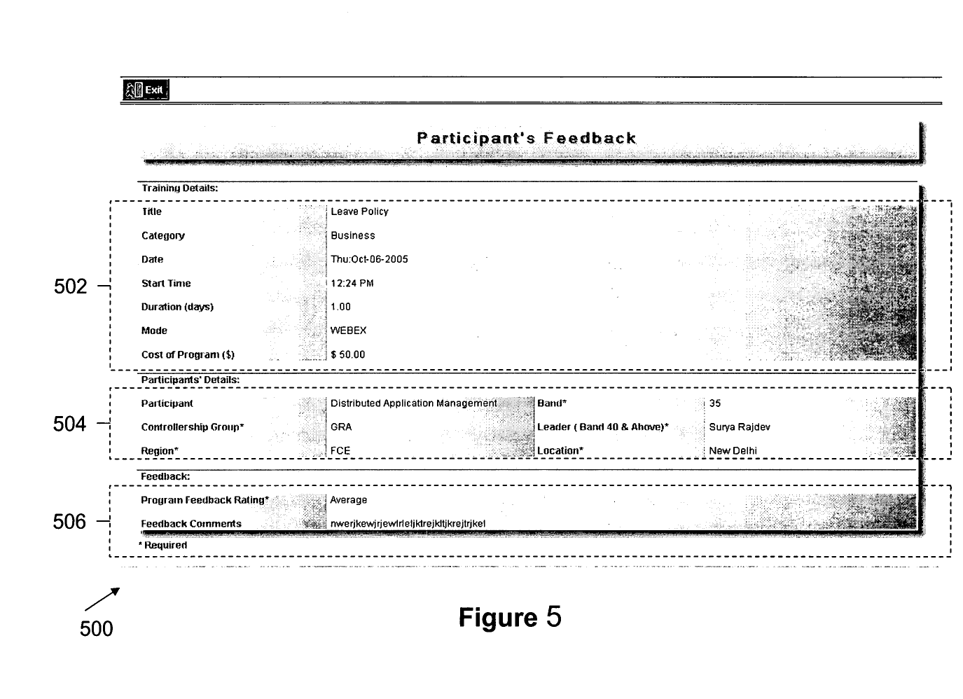

Operation of the various modules of system 300 is illustrated below with reference to FIGS. 5-7, each of which is an exemplary window or screenshot of the Graphical User Interface (GUI) of system 300. Referring first to FIG. 5, an exemplary window or screenshot 500 generated by the graphical user interface of system 300, according to an embodiment of the present invention, is shown. Screenshot 500 is a graphical user interface, which enables the user to input information related to the feedback of the one or more training program. In an embodiment of the present invention, the information may include, for example, a section of training details 502, a section of user details 504, and a section of feedback comments 506. Section of training details 502 includes the details of the training. Example of training details may include one or more categories such as the title, training type, date, duration, cost, location, mode, and the like. Section of user details 504 includes user details such as the user level, the user group, the user location, the name of the leader, and the like. Further, section of feedback comments 506 enables the user to fill the user comments. User comments may include, for example, but are not limited to, user rating, comments and suggestions on the training program. In an embodiment of the present invention, the user rating may be defined as poor, average, good or excellent. In another embodiment of the present invention, the user rating may be defined in a numerical range such as, but not limited to, 1-5. In another embodiment of the present invention, the user rating may be defined as alphanumeric.

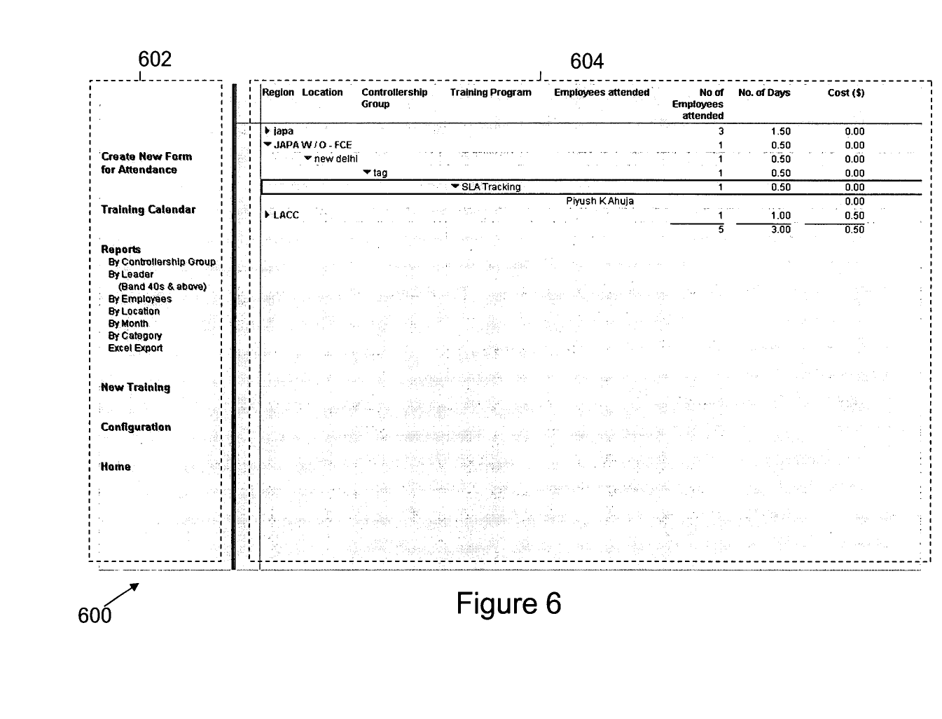

FIG. 6 is an exemplary window or screenshot 600 generated by the graphical user interface of system 300, according to an embodiment of the present invention. Screenshot 600 is a graphical user interface, which enables the user to generate one or more reports by various categories. In an embodiment of the present invention, screenshot 600 may include an option menu 602 for selecting an option and a program section 604 listing available training programs. Menu 602 enables the user to select various options such as the creation of the training program, the training calendar, the generation of reports, and the like. Further, the user may generate one or more reports, based on these options. For example, if a user selects an option such as location, and generates a report for a particular location, a location-wise report may be generated, which lists the details of the training programs scheduled for the particular location. Similar reports may be generated for a particular date, month, user, group, type of training, and the like. The program section 604 displays the lists of training programs, based on the option selected by the user.

FIG. 7 is an exemplary window or screenshot 700 generated by the graphical user interface of system 300, according to an embodiment of the present invention. Screenshot 700 is a graphical user interface, which enables the user to view the listing of the training programs in a calendar format. In an embodiment of the present invention, the user may view the list of training programs scheduled on a particular day or month in the calendar format.

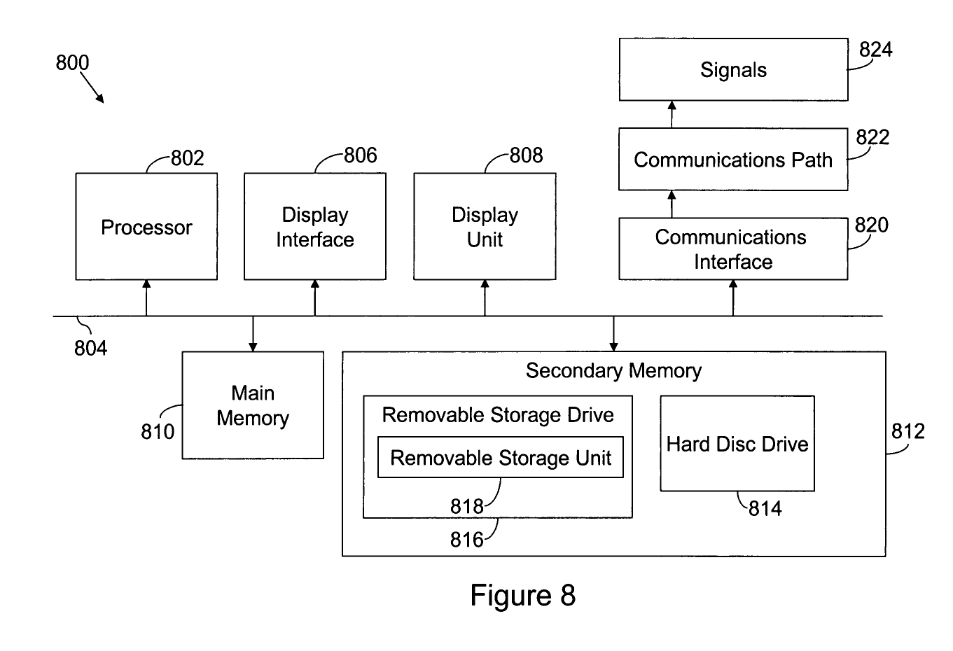

The present invention (i.e., system 200, system 300, process 400 or any part(s) or function(s) thereof) may be implemented using hardware, software or a combination thereof and may be implemented in one or more computer systems or other processing systems. However, the manipulations performed by the present invention are often referred to herein in terms, such as collecting, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices. An example of a computer system 800 is shown in FIG. 8.

Computer system 800 includes one or more processors, such as processor 802. Processor 802 is connected to a communication infrastructure 804 (e.g., a communication bus, cross-over bar, or network). Various software embodiments are described in terms of this exemplary computer system. After reading this description, it will become apparent to a person skilled in the relevant art(s) how to implement the invention using other computer systems and/or architectures.

Computer system 800 can include a display interface 806 that forwards graphics, text, and other data from communication infrastructure 804 (or from a frame buffer not shown) for display on a display unit 808. Computer system 800 also includes a main memory 810, preferably random access memory (RAM), and may also include a secondary memory 812. Secondary memory 812 may include, for example, a hard disk drive 814 and/or a removable storage drive 816, representing a floppy disk drive, a magnetic tape drive, an optical disk drive, etc. Removable storage drive 816 reads from and/or writes to a removable storage unit 818 in a well known manner. Removable storage unit 818 represents a floppy disk, magnetic tape, optical disk, etc., which is read by and written to by removable storage drive 816. As will be appreciated, removable storage unit 818 includes a computer usable storage medium having stored therein computer software and/or data.

In alternative embodiments, secondary memory 812 may include other similar devices for allowing computer programs or other instructions to be loaded into computer system 800. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system 800.

Computer system 800 may also include a communication interface 820. Communication interface 820 allows software and data to be transferred between computer system 800 and external devices. Examples of communication interface 820 may include a modem, a network interface (such as an Ethernet card), a communication port, a Personal Computer Memory Card International Association (PCMCIA) slot and card, etc. Software and data transferred via communication interface 820 are in the form of signals 824 which may be electronic, electromagnetic, optical or other signals capable of being received by communication interface 820. These signals 824 are provided to communication interface 820 via a communication path (e.g., channel) 822. This communication path 822 carries signals 824 and may be implemented using wire or cable, fiber optics, a telephone line, a cellular link, an radio frequency (RF) link and other communication channels.

In this document, the terms ‘computer program medium’ and ‘computer usable medium’ are used to generally refer to media such as removable storage drive 816, a hard disk installed in hard disk drive 814, and signals 824. These computer program products provide software to computer system 800. The invention is directed to such computer program products.

Computer programs (also referred to as computer control logic) are stored in main memory 810 and/or secondary memory 812. Computer programs may also be received via communication interface 820. Such computer programs, when executed, enable computer system 800 to perform the features of the present invention, as discussed herein. In particular, the computer programs, when executed, enable processor 802 to perform the features of the present invention. Accordingly, such computer programs represent controllers of computer system 800.

In an embodiment where the invention is implemented using software, the software may be stored in a computer program product and loaded into computer system 800 using removable storage drive 816, hard disk drive 814 or communication interface 820. The control logic (software), when executed by processor 802, causes processor 802 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein, without departing from the spirit and scope of the present invention. Thus, the present invention should not be limited by any of the exemplary embodiments described above, but should be defined only in accordance with the following claims and their equivalents.

In addition, it should be understood that the figures and screenshots illustrated in the attachments, which highlight the functionality and advantages of the present invention, are presented for exemplary purposes only. The architecture of the present invention is sufficiently flexible and configurable, such that it may be utilized (and navigated) in ways other than those shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting to the scope of the present invention in any way.

What is claimed is:

1. A method for managing a process through an e-mail client, the e-mail client connecting a plurality of users via a communication network, the method comprising the steps of:
(a) scheduling a dataset of the process on the e-mail client based on a category of the dataset;
(b) collecting feedback of the dataset on the e-mail client, the feedback being combined with the category; and
(c) generating a report of the dataset, where the report is based on the category associated with the dataset.

2. The method according to claim 1, wherein the scheduling step comprises scheduling the dataset based on a pre-defined scheduling right.

3. The method according to claim 1, wherein the scheduling step comprises notifying the users about the dataset.

4. The method according to claim 1, wherein the collecting step comprises collecting data concerning attendance of the users datasets.

5. The method of claim 1, further comprising the step of:
storing the feedback.

6. The method of claim 1, further comprising the step of:
modifying the feedback based on pre-defined modification rights.

7. The method of claim 1, further comprising the step of:
exporting the report in a pre-defined file format.

8. The method according to claim 1, wherein the category is at least one of date, duration, cost, location, title, mode, dataset type, username, user level and user group associated with the dataset.

9. The method according to claim 1, wherein
the scheduling step comprises scheduling a plurality of datasets of the process on the e-mail client based on a plurality of categories of the datasets;
the collecting step comprises collecting feedback of the datasets on the e-mail client, the feedback being combined with the categories; and
the generating step comprises generating a plurality of reports of the datasets, where the reports are based on the categories associated with the datasets.

10. A computer-based system for managing a process through an e-mail client, the e-mail client connecting a plurality of users via a communication network, comprising:
(a) a scheduling module to schedule a dataset of the process on the e-mail client based on a category of the dataset;
(b) a feedback collection module to collect feedback of the dataset on the e-mail client, the feedback being combined with the category; and
(c) a report-generating module to generate a report of the dataset, where the report is based on the category associated with the dataset.

11. The system of claim 10, further comprising:
an authorization module to authorize the users for scheduling the dataset.

12. The system of claim 10, further comprising:
a notification module to notify the users about the dataset.

13. The system of claim 10, further comprising:
a storing module to store the feedback.

14. The system of claim 10, further comprising:
an export module to export the report in a pre-defined file format.

15. The system of claim 10, wherein
the scheduling module schedules a plurality of datasets of the process on the e-mail client based on a plurality of categories of the datasets;
the collection module collects feedback of the datasets on the e-mail client, the feedback being combined with the categories; and
the report-generating module generates a plurality of reports of the datasets, where the reports are based on the categories associated with the datasets.

16. A computer program product comprising a computer usable medium having control logic stored therein for causing a computer to manage a process through an e-mail client, the e-mail client connecting a plurality of users via a communication network, the control logic comprising:
first computer readable program code means for scheduling a dataset of the process on the e-mail client based on a category of the dataset;
second computer readable program code means for collecting feedback of the dataset on the e-mail client, the feedback being combined with the category; and
third computer readable program code means for generating a report of the dataset, where the report is based on the category associated with the dataset.

17. The computer program product according to claim 16, wherein the first computer readable program code means for scheduling a dataset of the process on the e-mail client based on a category of the dataset notifies the users about the dataset.

18. The computer program product according to claim 16, wherein:
the first computer readable program code means schedules a plurality of datasets of the process on the e-mail client based on a plurality of categories of the datasets;
the second computer readable program code means collects feedback of the datasets on the e-mail client, the feedback being combined with the categories; and
the third computer readable program code means generates a plurality of reports of the datasets, where the reports are based on the categories associated with the datasets.
